(19) United States
(12) Patent Application Publication
(10) Pub. No.: US 2004/0160119 A1
(43) Pub. Date: Aug. 19, 2004

(54) Vaccum brake booster of a vehicle braking system and method for operating a vehicle braking system comprising one such vacuum brake booster

(76) Inventors: Wilfried Wagner, Huttenberg (DE); Hans-Jorg Feigel, Rosbach (DE); Ingo Knewitz, Neu Anspach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/479,369

(22) PCT Filed: May 27, 2002
(86) PCT No.: PCT/EP02/05797

(30) Foreign Application Priority Data
Jun. 2, 2001 (DE) 101 27 096.8
Apr. 27, 2002 (DE) 102 18 972.2

(51) Int. Cl. B60T 8/44

(52) U.S. Cl. 303/114.3

(57) ABSTRACT

In a vacuum brake booster of a vehicle braking system, comprising a vacuum housing that is subdivided by at least one movable partition into at least one vacuum chamber and at least one working chamber, comprising a sensor unit adapted to sense the pressure in the vacuum chamber and the pressure in the working chamber or the difference in pressure between the working chamber and the vacuum chamber, an electronic control unit is associated with the vacuum brake booster and includes an evaluation unit for the purpose of evaluating the sensed pressures in the vacuum chamber and the working chamber or the difference in pressure between the working chamber and the vacuum chamber. The electronic control unit includes an actuation unit for the purpose of actuating an active hydraulic brake force boosting unit on the basis of the evaluation by the evaluation unit.

### TECHNICAL FIELD

The present invention generally relates to vehicle brake systems and more particularly relate to a vacuum brake booster which uses active hydraulic boosting to supplement the vacuum brake booster.

### BACKGROUND OF THE INVENTION

Vacuum brake boosters require a vacuum supply made available by the engine for boosting the pedal force generated by the driver. Under certain operating conditions of the engine, additional force applied to the actuating unit is only possible by an increase in the pedal force. This can be the case because under certain engine operating conditions the vacuum brake booster can reach a maximum possible boosting force. This condition is referred to as the booster's point of maximum boosting.

If the maximally achievable boosting force is too low as a result of an only weak vacuum supply, which becomes more frequent in new engine technology such as direct injection engines or direct injection Diesel engines, additional brake force boosting becomes necessary. One possibility of generating additional brake force or additional brake pressure involves employing ‘active’ hydraulic brake force boosting, which is achieved by means of a hydraulic pump, for example. In active hydraulic brake force boosting, the hydraulic pressure resulting in the hydraulic master brake cylinder from the brake force introduced by the driver by way of the brake pedal which is partially boosted by means of a vacuum brake booster, is additionally increased by the hydraulic pump. Said pump is driven by an electric motor actuated by an electronic brake control unit.

Further, it is per se known to use pressure sensors in/on vacuum brake boosters for defined applications in order to detect and evaluate a difference in pressure between the low-pressure chamber or vacuum chamber and the working chamber.

DE 44 36 297 C2 discloses a vacuum brake booster and a method for operating a vehicle braking system wherein the sensed pressure difference is evaluated for actuating a control valve in the vacuum brake booster.

DE 197 29 158 C2 discloses a vacuum brake booster with a control unit that carries two pressure sensors with two air ducts extending into the vacuum chamber and the working chamber of the vacuum brake booster. The control unit is used to control the vacuum brake booster.

### BRIEF SUMMARY OF THE INVENTION

An object of the invention is to provide a vacuum brake booster and a control method for a vehicle braking system with active hydraulic boosting.

The object underlying the invention is achieved by a vacuum brake booster of a vehicle braking system, comprising a vacuum housing that is subdivided by at least one movable partition into at least one vacuum chamber and at least one working chamber, and a sensor unit for sensing pressures in the vacuum brake booster, which vacuum brake booster is characterized in that the sensor unit is provided to sense the pressure in the vacuum chamber and the pressure in the working chamber or the difference in pressure between the working chamber and the vacuum chamber, that associated with the vacuum brake booster is an electronic control unit that includes an evaluation unit for the purpose of evaluating the sensed pressures in the vacuum chamber and the working chamber or the difference in pressure between the working chamber and the vacuum chamber, and that the electronic control unit includes an actuation unit for the purpose of actuating an active hydraulic brake force boosting unit on the basis of the evaluation by the evaluation unit.

The vacuum brake booster is used to determine the pressure condition of the vacuum chamber and the working chamber and/or the difference in pressure of the chambers, to generate characteristic signals thereof and send the signals to the electronic control unit where they are evaluated. According to the evaluation an actuating signal for an active hydraulic brake force boosting unit, preferably an electric-motor and pump unit, can be produced in order to develop or control additional brake pressure. The additional (hydraulic) brake pressure can be reliably introduced and controlled because pressure conditions and, thus, the possible boosting effect by the vacuum can be determined reliably and precisely.

According to the invention the sensor unit is provided to sense the difference in pressure between the pressure prevailing in the vacuum chamber and the working chamber and to produce a signal characteristic of the sensed pressure difference for the electronic control unit. Consequently, the difference in pressure between the vacuum chamber and the working chamber is sensed ‘directly’ by the sensor unit in this embodiment. The signal characteristic of the pressure difference is sent to the evaluation unit and evaluated therein. An actuating signal for the active hydraulic brake force boosting unit can then be generated by means of the actuation unit according to the evaluation.

The invention arranges for the sensor unit to sense the pressures prevailing in the vacuum chamber and the working chamber with respect to a ‘standardized’ pressure, preferably with respect to the outside pressure (ambient pressure) and to generate signals characteristic of the sensed pressures in the vacuum chamber and the working chamber for the electronic control unit. The term ‘outside pressure’ in this context refers to the pressure of the ambient atmosphere (ambient pressure). Thus, the pressure unit senses two pressure signals, meaning one signal for the pressure in the vacuum chamber and one for the pressure in the working chamber. The signals characteristic thereof are sent to the evaluation unit and evaluated therein. According to the evaluation, an actuating signal for an active hydraulic brake force boosting unit can be produced by means of the actuation unit, in particular by means of a unit for producing an actuating signal for an electric-motor and pump unit. This renders it possible to actuate the hydraulic brake force boosting unit in the way of build-up or control of additional brake pressure. This embodiment of the sensor unit with separating sensing of the pressures in the vacuum chamber and the working chamber is preferred. The reason is a comparison made between the sensed pressure in the vacuum chamber and the sensed pressure in the working chamber by means of the electronic evaluation unit in the electronic control unit. As there is no need for electronic evaluating components and/or control components in or on the housing of the sensor unit, it is possible to design the housing in a very small, compact and light-weight manner.

It is provided by the invention that the sensor unit includes a first sensor element for sensing the pressure or the vacuum in the vacuum chamber and a second sensor element for sensing the pressure in the vacuum chamber and that both sensor elements are accommodated in one common housing. The advantage involved with this embodiment is that the pressure conditions in both chambers of the vacuum brake booster can be sensed individually with one single component uniting the functions of two pressure or vacuum sensors (‘dual pressure sensor unit or dual vacuum sensor unit’). This means that there is provision of a first sensor element for sensing the differential pressure between the vacuum chamber and the ambient pressure and a second sensor element for sensing the differential pressure between the vacuum chamber and the ambient pressure in one common housing. Both sensor elements are arranged preferably adjacent each other in the housing.

According to the invention, the housing of the sensor unit is arranged at least in part within the vacuum housing, preferably at least in part within the vacuum chamber. In this case, the housing is preferably so configured and/or arranged that the first and second sensor element are arranged in the interior of the vacuum brake booster, preferably within the vacuum chamber. This means that the sensor elements are arranged inside the walls of the vacuum housing that limit the vacuum brake booster.

Preferably, the housing of the sensor unit has a tubular or hose-type connecting line that penetrates the movable partition. A length of the connecting line is provided that is at least adequate for the connecting line to penetrate the partition in all possible positions. This ensures a connection between the sensor element for sensing the working chamber pressure with the working chamber in all actuating positions of the vacuum brake booster.

According to the invention the sensor unit in braking systems with a master brake cylinder, in particular tandem master brake cylinder, is arranged at the wall of the vacuum housing close to the master brake cylinder. Favorably, the sensor unit can then be integrated into the housing or housing component close to the master brake cylinder.

It is arranged for by the invention that the sensor unit includes a four-pole plug coupling for the electrical connection of the sensor unit to the control unit, for the purpose of transmission of the signals of two sensor elements. In addition, arrangements are made for defined applications that the vacuum brake booster includes an electromagnetically controllable control valve for controlling the boosting force. This feature can realize a brake assistant function, for example.

According to the invention, the electronic control unit includes a detection unit for detecting a requirement of additional brake boosting for the driver, and the purpose of the actuation unit is to actuate the active hydraulic brake force boosting unit for developing additional hydraulic pressure when the requirement of additional brake boosting for the driver was detected by the detection unit.

The object underlying the invention is also achieved by a method of operating a vehicle braking system comprising a vacuum brake booster with at least one vacuum chamber and at least one working chamber wherein the pressure prevailing in the vacuum chamber and the working chamber is sensed, in which method the sensed pressures are supplied to an electronic brake control unit for evaluation purposes and, according to the evaluation, active hydraulic brake force boosting is carried out with a view to developing or controlling additional brake pressure. Favorably, hydraulic brake force boosting also permits the use a vacuum brake booster with a relatively low capacity, meaning a low boosting force, which requires a correspondingly smaller mounting space.

According to the invention, the evaluation also comprises the detection of a need for additional brake boosting, and that the active hydraulic brake force boosting is activated only in case of need, when the requirement of additional brake boosting for the driver is detected. It is then possible to generate additional hydraulic pressure only in defined situations. It is arranged for to use the additional hydraulic pressure as a braking assistance for the driver preferably only in a ‘cold-running phase’ of a combustion engine, this means when the engine has not yet reached an adequate operating temperature, with the result that the vacuum output of the combustion engine is insufficient to be used for the driver's brake boosting. This lacking vacuum output can often be found in combustion engines with direct injection, in particular direct fuel injection engines. It is therefore provided to implement the invention vacuum brake booster and the method preferably for vehicle braking systems wherein the vacuum for brake force boosting is produced by a combustion engine with direct injection, in particular a direct fuel injection engine.

The invention also arranges for that the evaluation also comprises the detection of the point of maximum boosting being reached or at least an approximation to the point of maximum boosting, and that the active hydraulic brake force boosting is activated only when the point of maximum boosting is reached or at least the approach to the point of maximum boosting is detected. In particular in the above-mentioned vacuum supply of the vacuum brake booster by a combustion engine with direct injection, the point of maximum boosting can be reached already too early in the cold-running phase when lack in vacuum output of the engine impairs a sufficient boosting function by the brake booster. Additional hydraulic brake force boosting will be activated in this case when the point of maximum boosting is reached and with continued brake pressure requirement issued by the driver.

According to the invention the boosting force of the vacuum brake booster and/or hydraulic brake force boosting is adjustable according to further functions of the brake control system such as brake assistant and driving dynamics control (ESP). The adjustment may e.g. be carried out by means of an electromagnetically controllable control valve in the vacuum brake booster by which the pressure difference between working chamber and vacuum chamber is adjustable.

It is also arranged for that the evaluation of the sensed pressures equally comprises the detection of failure or malfunction of brake force boosting by the vacuum brake booster. When failure or malfunction is detected, hydraulic brake force boosting can be adjusted and activated accordingly in order to compensate the malfunction at least in part, and corresponding modification of brake control and/or driver's warning is possible.

### BRIEF DESCRIPTION OF THE DRAWINGS

FIG. 1 is a cross-sectional view of a vacuum brake booster in a first position.

FIG. 2 is a partial enlarged cross-sectional view of a vacuum brake booster according to FIG. 1.

FIG. 3 is a cross-sectional view of a vacuum brake booster according to FIG. 1 in a second position.

FIG. 4 is an enlarged partial view of a cross-section taken through the vacuum brake booster according to FIG. 3.

FIG. 5 is a cross-sectional view of a vacuum brake booster according to FIG. 1 in a third position.

FIG. 6 is an enlarged partial cross-sectional view of the vacuum brake booster according to FIG. 5.

FIG. 7 is a cross-sectional view of a sensor unit with two sensor elements.

FIG. 8 is a cross-sectional view of a sensor unit with a sensor element for determining the pressure in the working chamber.

FIG. 9 is a cross-sectional view of a sensor unit with a sensor element for determining the pressure in the vacuum chamber.

### DETAILED DESCRIPTION OF THE PREFERRED EMBODIMENTS

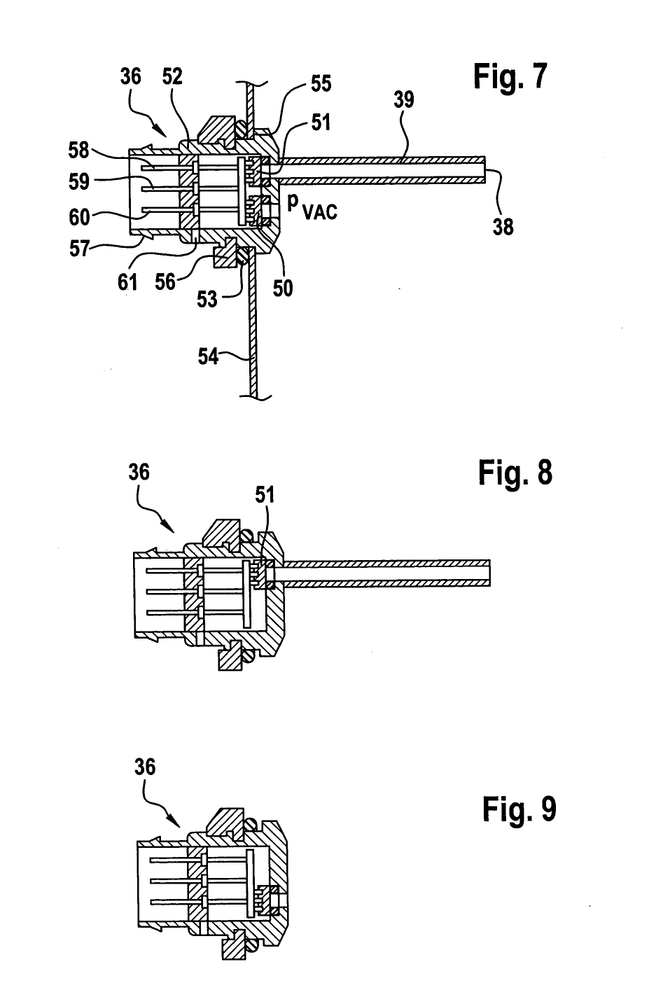

The same brake booster is illustrated in different positions in FIGS. 1 to 6, and a sensor element is shown in various embodiments in FIGS. 7 to 9. The components shown are essentially identical for the corresponding illustrations and fulfill the same functions so that repeated description of the functions and illustration of the reference numerals has been omitted.

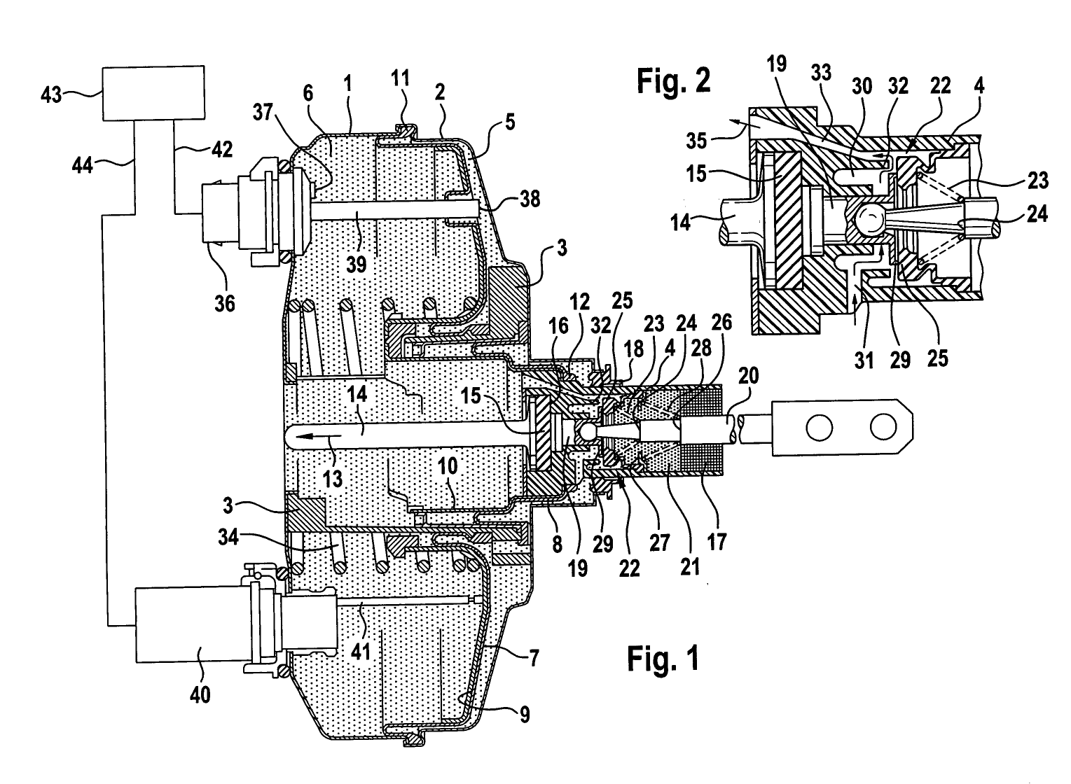

The vacuum brake booster shown in FIG. 1 and FIG. 2 includes a vacuum housing composed of a bowl 1 and a cover 2. The two housing shells 1, 2 have a double function: they transmit the actuating forces from the pedal to the master cylinder (not shown) connected to the brake force booster, and they are used as vacuum reservoirs. Force transmission takes place by way of a tie rod construction. A centrically arranged central tube 3 serves for rigid interconnection of the two flange sides of the unit. The housing is thereby relieved from transmission forces and only required to take up the pressure difference between atmosphere (ambient air) and vacuum. The vacuum housing is subdivided into a working chamber 5 and a vacuum chamber 6. A rubber diaphragm 7, 8 axially movable with a control hub 4 and a partition 9, 10 provides this separation. The arrangement of the central tube 4 necessitates the two-part rubber diaphragm 7, 8 and two-part partition 9, 10. The outside edge 11 of the outer diaphragm 7 is sealingly compressed between bowl and cover in the vacuum housing, and the inside edge 12 of the inner diaphragm 8 is sealingly compressed in the control hub 4. Diaphragm 7, 8 rests against the side of the partition 9, 10 close to the working chamber 5 and thus seals the vacuum chamber 6 in relation to working chamber 5. Partition 10 is form-lockingly held at the end face of the control hub 4 facing the force output direction 13. As this occurs, partition 10 presses the inside edge of rubber diaphragm 8 against control hub 4. The force output occurs by way of a force output member 14 being supported on a step 16 by way of reaction disc 15. On the other side, control hub 4 projects through the cover 2 and is opened axially towards the atmosphere by way of a filter 17. Working chamber 5 is sealed towards the ambience by means of a seal 18 that is inserted form-lockingly into the cover.

Force transmission to the reaction disc 15 takes place by way of a valve piston 19 that is clamped movably, yet without axial play, onto the spherical head of a stepped piston rod 20. Piston rod 20 penetrates an air space 21 and is in connection with an actuating pedal (not shown). A poppet valve 22 penetrated by the piston rod with play is inserted into air space 21.

Inserted within the poppet valve 22 is a spring 23 which is supported on a first step 24 of piston rod 20 and urged against valve plate 25. Force is applied to piston rod 20 in opposition to the force output direction 13 by another spring 28 that acts between another step 26 of the piston rod 20 and a plate 27 so that the mechanically connected valve piston 19 with its annular sealing edge 29 moves into sealing abutment on the valve plate 25 and thereby separates the air space 21 from the interior of the booster. A space 36 is then isolated around the valve piston and connects to the working chamber 5 by way of opening 31. Disposed radially outside above a step 32, chamber 30 is connected to the vacuum chamber 6 by way of a channel 33 in control hub 4.

The rest position of the vacuum brake booster shown in FIG. 1 and FIG. 2 is determined by spring 34 pushing the partition 9, 10 in opposition to the force output direction 13 until the rubber diaphragm 7, 8 abuts on the cover 2 of the vacuum housing. In the inactive position of the pedal, abutment of sealing edge 29 of valve piston 19 on the valve plate 25 shuts off the air supply to the working chamber 5. Thus, vacuum prevails in the working chamber 5 (illustrated by a weakly dotted space in FIG. 1) because working chamber 5, as shown in FIG. 1 and FIG. 2, is connected to the vacuum chamber 6 (illustrated by a weakly dotted space in FIG. 1) by way of openings 31, space 30 around step 32, channel 33, and because vacuum chamber 6 is connected by way of a connection (not shown) to a continuously operating low-pressure source or vacuum source (not shown) (illustrated by arrows 35).

As shown in FIG. 1, the pressure in working chamber 5 and vacuum chamber 6 is measured by means of a sensor unit 36. To this end, a first sensor element (not shown herein) of sensor unit 36 is in connection to vacuum chamber 6 by way of a first opening 37, and a second sensor element (not shown herein) is in connection to the working chamber by way of a second opening 38 in a small connecting tube 39 that penetrates the movable wall 9. Instead of the small connecting tube 39, a hose or any similar flexible connecting line may be arranged. Sensor unit 36 can be mounted from the inside of the vacuum brake booster or from the outside of the vacuum brake booster. The sensor unit 36 is a fixed component of the brake force booster in the first mentioned case. In a case of replacement, the entire vacuum brake booster will have to be exchanged. Therefore, the embodiment shown herein is preferred to be equipped with a sensor unit 36 arranged on the booster's outside. Preferably, said unit is mounted on an output-side area of the vacuum brake booster as shown in FIG. 1. This means on the side in the direction of which the force output member 14 acts for brake pressure generation. In this special embodiment, a travel sensor 40 is also arranged on this side. Sensor 40 senses with pin 41 the position or the travel of partition 9. However, travel sensor 40 is not needed in general. Preferred embodiments therefore comprise vacuum brake boosters without the travel sensor 40 shown herein.

In the illustrated position, the sensor unit 36 does not detect a difference between the pressures measured by the first and the second sensor element because the connection to the ambient air is interrupted and the channel to the vacuum chamber closed. This position corresponds to an inactive position or release position of the vacuum brake booster.

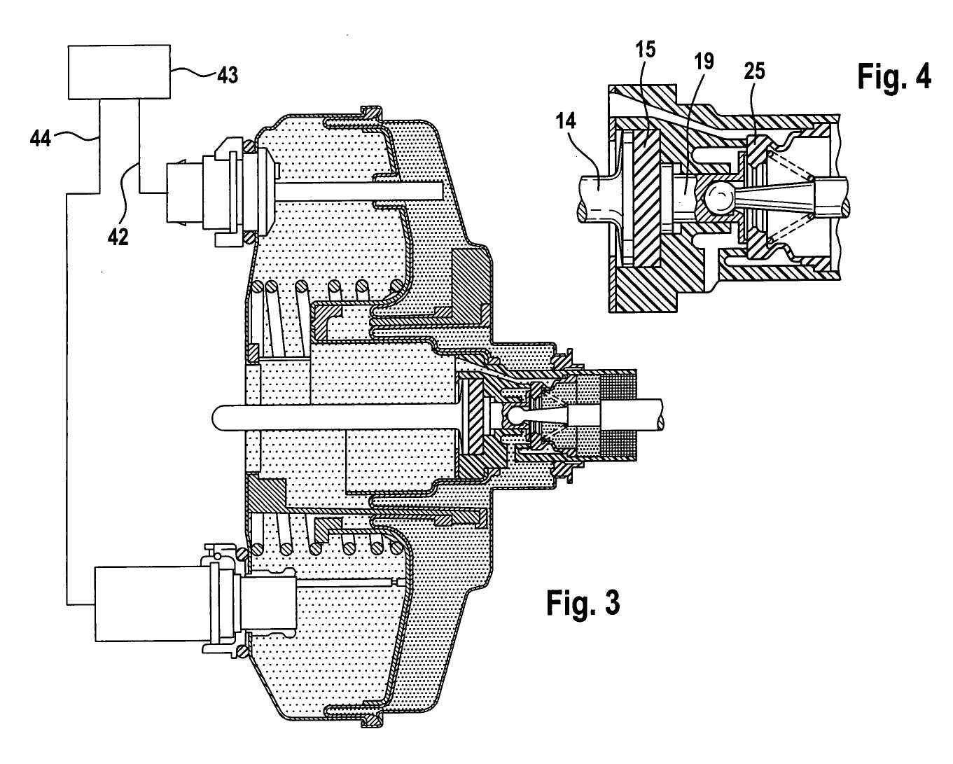

When the pedal is depressed and, thus, piston rod 20 and valve piston 19 displaced, poppet valve 22 will follow this movement until valve plate 25 bears against step 32. Channel 33 is then isolated from the rest of chamber 30, and vacuum chamber 6 and working chamber 5 are no longer in connection. In the further course of movement, also the connection to the ambient air will be opened by poppet valve 25, and the vacuum starts to decrease behind the diaphragm 7, 8. Hydraulic pressure developing in a master brake cylinder that follows the vacuum brake booster in the force output direction 13 will bring the pistons in the master brake cylinder and the force output member 13 and, transmitted by reaction disc 15, also valve piston 19 to standstill. Simultaneously, poppet valve 25 will close and thereby stop any further ambient air supply. The ready position reached now is depicted in FIG. 3 and FIG. 4.

In the ready position or partial braking position each insignificant change in the pedal force will cause increase or decrease of the pressure difference on both sides of partition 9, 10 and, by way of the master brake cylinder, an increase or reduction of the hydraulic pressure in the braking system and, hence, deceleration. Sensor unit 36 determines the pressure difference between working chamber 5 (shown by a more significantly dotted space in FIG. 3) and vacuum chamber 6 (shown by a weakly dotted space in FIG. 3) by means of the associated sensor elements. Sensor unit 36 produces a signal characteristic of the pressure difference. Said signal is sent to a control unit 43 by way of line 42. Likewise the signal of the travel sensor 40 is sent via line 44 to control unit 43 and evaluated there. According to the evaluation, an actuating signal for an active hydraulic brake force boosting unit can be produced with a view to developing additional brake pressure if the brake pressure solely produced by the vacuum brake booster in the master brake cylinder is too low.

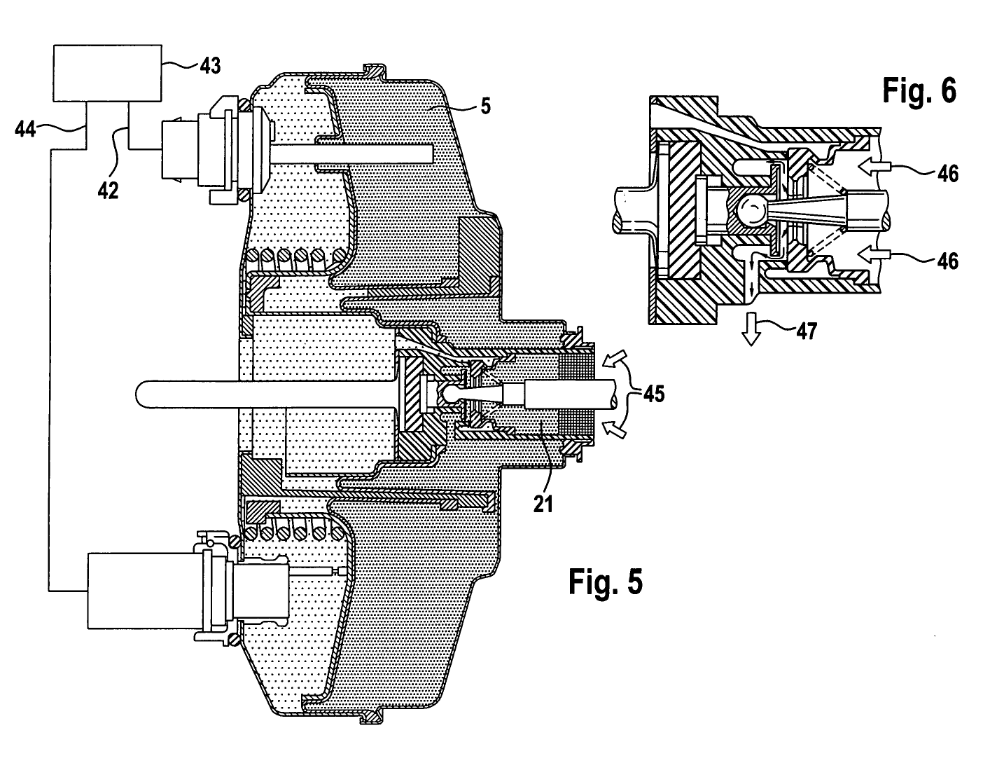

When depression of the pedal is continued, part of the force is conducted by way of reaction disc 15 directly to the force output member 14. However, the sealing edge 29 of valve piston 19 will simultaneously lift from valve plate 25 and connect chamber 30 to the air space 21 and thus to the atmosphere. This is shown in FIG. 5 and FIG. 6. Now air will flow out of the atmosphere (arrows 45 in FIG. 5) in an axial direction through the poppet valve 25 (arrows 46 in FIG. 6) and then into chamber 30 and from here through opening 31 into working chamber 5. The developing pressure difference between working chamber 5 and vacuum chamber 6 tends to shift partition 9, 10 in the force output direction 13. The pressure in chamber 21 (atmospheric pressure) now corresponds to the pressure in working chamber 5 (illustrated by thickly dotted spaces in FIG. 5), while the pressure of the vacuum chamber corresponds to a vacuum produced due to the connected vacuum source (shown by the weakly dotted space in FIG. 5). All developing forces are transmitted by partition 10 to force output member 14. Control hub 4 remains free from these actuating forces.

The magnitude of the difference in pressure between working chamber 5 (thickly dotted space) and vacuum chamber 6 (weakly dotted space) represents the maximum force that the vacuum booster an generate when a full braking position of the vacuum brake booster is called for. Thereafter, any further increase of the force applied to the master brake cylinder piston is possible only by a still higher pedal force exerted by the driver. Sensor unit 16 will generate a signal characteristic of this pressure difference and indicating that the point of maximum boosting is reached. If the maximum possible boosting force of the vacuum brake force booster is not sufficient when the driver demands further brake pressure increase, control unit 43 will then produce an actuating signal for active hydraulic brake force boosting in the sense of build-up of additional brake pressure.

The vacuum brake booster can include an electronically controlled valve for defined systems, which is used to control the pressure difference that acts on partition 9, 10 (active booster, not illustrated herein).

FIGS. 7 to 9 show cross-sectional views of sensor unit 36.

In sensor unit 36 of FIG. 7, the pressure of vacuum chamber 6 is sensed by a first sensor element 50, and the pressure in working chamber 5 is sensed by way of a second sensor element 51. A base member or a common housing 52 of sensor unit 36 is connected herein to the small connecting tube 39, which penetrates the partition (cf. FIGS. 1, 3, 5), by way of opening 38 to working chamber 5. A flexible connecting line, e.g. hose, may be provided instead of a small connecting tube. Said sensor unit is fitted e.g. to bowl 1 on the side close to the master brake cylinder, and the interior of said bowl is vacuum-tightly sealed by way of an elastic seal 53 by compressing the bowl wall 54 between an edge 55 of housing 52 and seal 53. Favorably, a threaded ring 56 that presses seal 53 against wall 54 of bowl 1 and edge 55 can be used for the assembly. The individual pressure elements 50, 51 can sense the pressure difference or the absolute pressure, as required. The electrical connection to the electronic control unit 43 of the vehicle braking system or any other control device may be established by means of only one plug coupling 57. Plug coupling 57 includes at least three pins 58, 59, 60, yet preferably four pins. In the sensor unit shown, the atmospheric pressure is measured as a reference pressure by establishing a connection to the ambient atmosphere by way of opening 61.

Sensor unit 36 in FIG. 8 and FIG. 9, what is in contrast to FIG. 7, includes only one sensor element either sensing the pressure in working chamber 5 (51 in FIG. 8) or the pressure in vacuum chamber 6 (50 in FIG. 9). In other respects the design mainly corresponds to the sensor unit illustrated in FIG. 7 and, therefore, will not be explained in detail. For this reason, like components have been assigned like reference numerals also in this case.

However, the design with two sensor elements 50, 51 according to FIG. 7 in a housing is preferred. The reason is that this ‘dual pressure sensor’ can be treated like one sensor during the entire process chain from the manufacturer of the sensor unit via the manufacturer of the vacuum brake booster up to the vehicle manufacturer, although it provides the functionality of two pressure sensors sensing the pressure at absolutely different locations in the brake booster. Cost benefits are thereby achieved because only one component is needed, and assembly advantages because connection of the sensor unit is possible with only one plug coupling. The construction and arrangement of sensor unit 36 according to FIG. 7 is advantageous also in terms of packaging. Normally, up-to-date vehicles make available a larger mounting space on the side of the master brake cylinder than on the pedal side of a vacuum brake booster so that the arrangement on the master brake cylinder side is preferred. However, the mounting space available lessens also in the engine compartment of modern vehicles. Therefore, a common housing 52 for the first sensor element 50 and the second sensor element 51 is arranged for in a particularly preferred manner, which housing itself does not include units for the electronic evaluation or processing of the sensor signals, e.g. electronic circuits, so that a construction as compact as possible can be realized. Space requirement in the engine compartment is further reduced by means of at least partly integrating housing 52 in the vacuum housing, especially the vacuum chamber.

1. Vacuum brake booster of a vehicle braking system, comprising a vacuum housing that is subdivided by at least one movable partition into at least one vacuum chamber and at least one working chamber, and a sensor unit for sensing pressures in the vacuum brake booster,
characterized in that the sensor unit is provided to sense the pressure in the vacuum chamber and the pressure in the working chamber or the difference in pressure between the working chamber and the vacuum chamber, in that associated with the vacuum brake booster is an electronic control unit that includes an evaluation unit for the purpose of evaluating the sensed pressures in the vacuum chamber and the working chamber or the difference in pressure between the working chamber and the vacuum chamber, and in that the electronic control unit includes an actuation unit for the purpose of actuating an active hydraulic brake force boosting unit on the basis of the evaluation by the evaluation unit.

2. Vacuum booster as claimed in claim 1,
characterized in that the sensor unit is used to sense the difference in pressure between the pressure prevailing in the vacuum chamber and the working chamber and to produce a signal characteristic of the sensed pressure difference for the electronic control unit, and in that the signal characteristic of the difference in pressure is evaluated in the evaluation unit, and an actuating signal for the active hydraulic brake force boosting unit is generated by means of the actuation unit according to the evaluation.

3. Vacuum booster of a vehicle braking system,
characterized in that the sensor unit is used to sense the pressures prevailing in the vacuum chamber and the working chamber with respect to the ambient pressure and to generate signals characteristic of the sensed pressures in the vacuum chamber and the working chamber for the electronic control unit, in that the signals characteristic of the pressures are evaluated in the evaluation unit and, according to the evaluation, an actuating signal for an active hydraulic brake force boosting unit is generated by means of the actuation unit.

4. Vacuum booster as claimed in claim 1 or 2,
characterized in that the sensor unit includes a first sensor element for sensing the pressure in the vacuum chamber and a second sensor element for sensing the pressure in the vacuum chamber, and in that both sensor elements are accommodated in one common housing.

5. Vacuum booster as claimed in claim 4,
characterized in that the housing of the sensor unit is arranged at least in part within the vacuum housing, preferably at least in part within the vacuum chamber, and includes a tubular or hose-type connecting line that penetrates the movable partition.

6. Vacuum booster as claimed in claim 4 or 5,
characterized in that the first and second sensor element is arranged in the interior of the vacuum brake booster, preferably inside the vacuum chamber.

7. Vacuum booster as claimed in any one of claims 1 to 6,
characterized in that in braking systems with a master brake cylinder, in particular tandem master brake cylinder, the sensor unit is arranged at the wall of the vacuum housing close to the master brake cylinder.

8. Vacuum booster as claimed in any one of claims 1 to 7,
characterized in that the sensor unit includes a tubular or hose-type connecting line that penetrates the movable partition.

9. Vacuum booster as claimed in any one of claims 1 to 8,
characterized in that the electronic control unit includes a detection unit for detecting the driver's demand for additional brake boosting, and that the actuation unit is used to actuate the active hydraulic brake force boosting unit for developing additional hydraulic pressure when the requirement of additional brake boosting for the driver was detected by the detection unit.

10. Method of operating a vehicle braking system comprising a vacuum brake booster with at least one vacuum chamber and at least one working chamber, wherein the pressure prevailing in the vacuum chamber and the working chamber is sensed,
characterized in that the sensed pressures are supplied to an electronic brake control unit for evaluation purposes and, according to the evaluation, active hydraulic brake force boosting is carried out with a view to developing or controlling additional brake pressure.

11. Method as claimed in claim 10,
characterized in that the evaluation also comprises the detection of a need for additional brake boosting, and that the active hydraulic brake force boosting is activated only in case of need, when the requirement of additional brake boosting for the driver is detected.

12. Method as claimed in claim 10 or 11,
characterized in that the evaluation also comprises the detection of the point of maximum boosting being reached or at least an approximation to the point of maximum boosting, and in that the active hydraulic brake force boosting is activated only when the point of maximum boosting is reached or at least the approximation to the point of maximum boosting was detected.

13. Method as claimed in any one of claims 10 to 12,
characterized in that the boosting force of the vacuum brake booster and/or the hydraulic brake force boosting is adjustable according to other functions of the brake control system such as brake assistant and driving dynamics control (ESP).
